(19) United States
(12) Patent Application Publication
(10) Pub. No.: US 2012/0084061 A1
(43) Pub. Date: Apr. 5, 2012

(54) THREE DIMENSIONAL SIMULATION METHOD

(75) Inventors: Yukihiko FURUMOTO, Kawasaki (JP); Kouji Demizu, Kawasaki (JP); Naoyuki Nozaki, Kawasaki (JP); Masayuki Kidera, Kawasaki (JP)

(73) Assignee: FUJITSU LIMITED, Kawasaki-shi (JP)

(21) Appl. No.: 13/230,312

(22) Filed: Sep. 12, 2011

(30) Foreign Application Priority Data
Sep. 30, 2010 (JP) 2010-222931

(51) Int. Cl. G06F 17/50

(52) U.S. Cl. 703/1

(57) ABSTRACT

A three-dimensional simulation apparatus includes a memory storing shape data on a three-dimensional model of a linear flexible object, and a processor executing specifying data that forms sections of the linear flexible object from the shape data, determining reference positions on the sections, specifying data that forms a side surface that connects together the sections, extracting a curve that passes on the side surface, specifying a distance from an outer edge of the section that the extracted curve passes to the reference position, specifying a normal direction of the side surface at the position, specifying a path that connects together the reference positions by shifting the curve by the amount corresponding to the specified distance in a direction opposite to the specified normal direction of the side surface, and specifying a flexible model of the linear flexible object from the shape of each section, the reference positions and the path.

### CROSS-REFERENCE TO RELATED APPLICATION

This application is based upon and claims the benefit of priority of the prior Japanese Patent Application No. 2010-222931, filed on Sep. 30, 2010 the entire contents of which are incorporated herein by reference.

### FIELD

The embodiments discussed herein are related to a three-dimensional simulation technique.

### BACKGROUND

Three-dimensional CAD is used for development of various products each including a plurality of components. Three-dimensional CAD (Computer Aided Design) is a technique of designing a product by constructing a product model including three-dimensional shape data of a plurality of components in a virtual three-dimensional space by execution of arithmetic operations using a computer.

In three-dimensional CAD, in some cases, a product is displayed in the form of a solid model (a rigid body) which is one of techniques of expressing an object in a solid. In the solid model, since a product is modeled by defining the shape of each component included in the product strictly in mathematics, use of the solid model allows to accurately express a static assembled state of the product.

In assembling the product, each component is moved, for example, by the hand of an operator. In the case that the product is a mechanical one, in some cases, movable parts may be included. It is desirable to verify whether it is allowed to assemble the product with no problem or whether the movable parts of the product normally function in designing the product. However, since in the solid model, the shape of each component is defined strictly in mathematics, in the case that a dynamic state such as the operation of the component or the like is to be expressed, the amount of operations may be greatly increased.

Thus, simulation software such as, for example, Digital Mock-Up (hereinafter, referred to as DMU) or the like is adopted in three-dimensional CAD. DMU is a system that constructs a product model in a virtual three-dimensional space by executing arithmetic operations using a computer to simulate the function, assemblability and operability of a product. DMU may make is possible to simulate, for example, behaviors of a product model and an operator model, a product assembling operation and a product maintaining operation. DMU may also make it possible to readily perform dynamic verification entailing movement of a component by greatly increasing the operability of the system as compared with expression using a solid model. Use of DMU may make it possible to find such an inconvenience that would not be found unless a prototype is prepared at an earlier stage than ever.

In some cases, a product may include a flexible and deformable linear flexible object in a part of a component. As examples of the linear flexible object, for example, a thread, a string, a cord, a cable, a wire, a harness obtained by working a wire or a cable and the like may be given. For example, it may be unavoidable to complete designing of both a mechanical system and an electric system to some extent in order to determine wiring of a harness which is one of linear flexible objects. Therefore, designing of the harness has been postponed so far. For example, it may be practiced that after a prototype of a product has been finished, an actual harness is incorporated into the prototype and then the length is adjusted. Therefore, it may sometimes occur that finding of an inconvenience relating to the harness is delayed. In a product on which components are mounted highly densely, in some cases, large-scale rework may occur owing to occurrence of such various inconveniences that it is unavoidable to forcibly bend the harness, the fitting operability is low, and the harness interferes with other components and units. Therefore, it is desirable to start designing and verification of a harness at a relatively early design stage of a product.

A technique of supporting arrangement design of a harness in a designing object device into which a harness is incorporated is proposed (for example, Japanese Patent No. 4084800). Techniques each having a function of supporting harness design in three-dimensional CAD are proposed (for example, “I-DEAS Harness Design”: Siemens PLM Software, http://www.ugs.jp/product/nx/harness.html, and “Pro/ENGINEER Piping and Cabling Extension”: PTC, http://www.ptc.com/products/proengineer/piping-and-cabling-extension). DMU techniques each having a function of verifying a harness are proposed (for example, “VPS/Harness”: Fujitsu, http://jp.fujitsu.com/solutions/plm/virtual/vps/harness.html, and “Landmark View Harness Designer”: Landmark Technology, http://www.landmark.jp/products/harness/harness1.html).

In a model of a product which is expressed in the form of a solid model, dynamic verification of movement of a harness when assembling the product or moving a movable part may lead to an increase in amount of operations and hence much time may be taken. In the case that a shape model of a harness which is expressed in the form of a solid model is to be verified in DMU, the harness is incorporated into DMU as a solid model (a rigid body). Therefore, it may be difficult to verify the harness which has been incorporated into DMU as a linear flexible object. Accordingly, a designer defines the harness over again in DMU and hence such a problem may occur that the number of processes to be performed in designing a product is increased.

### SUMMARY

According to an aspect of the invention, a three-dimensional simulation apparatus includes a memory that stores shape data on a three-dimensional model of a designing object device including a linear flexible object, and a processing unit executing reading out the shape data stored in the memory, specifying data that forms sections of the linear flexible object from the read-out shape data, determining reference positions on the specified sections, specifying data that forms a side surface that connects together the sections of the linear flexible object from the read-out shape data, extracting a curve that passes on the side surface that connects together the sections from the specified side surface forming data, specifying a distance from an outer edge of the section that the extracted curve passes to the reference position on the section, specifying a normal direction of the side surface at the position of the extracted curve, specifying a path that connects together the reference positions on the sections by shifting the curve by the amount corresponding to the specified distance in a direction opposite to the specified normal direction of the side surface, and specifying a flexible body model of the linear flexible object from the shape of each section, the reference positions and the path.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating an example of a three-dimensional CAD device according to an embodiment;

FIG. 2 is a diagram illustrating an example of a hardware configuration of a computer system (a three-dimensional CAD device) for implementing a three-dimensional CAD device according to one embodiment;

FIG. 3 is a diagram illustrating an example of a wire harness according to an embodiment;

FIG. 4 is a diagram illustrating an example of a solid model of a harness according to an embodiment which is prepared on the basis of polygon data;

FIG. 5 is a diagram illustrating an example of a data format of a solid model of a harness according to an embodiment;

FIG. 6 illustrates an example of a flowchart of a process of calculating DMU-based data from a solid model of a harness expressed using polygons;

FIG. 7 is a diagram illustrating an example of a first section of a harness which is prepared using polygons;

FIG. 8 is a diagram illustrating an example of a second section of the harness which is prepared using polygons;

FIG. 9 is an example of a flowchart of a process of specifying a polyline;

FIG. 10 a diagram illustrating an example of a polyline that connects together sections of a harness;

FIG. 11 is a diagram illustrating an example of each path that connects together passing points of respective sections of a harness;

FIG. 12 is a diagram illustrating an example of a data format of DMU-based data of a harness according to an embodiment;

FIG. 13 is a diagram illustrating an example of surface data indicating the shape of a harness according to an embodiment which is prepared by combining a plurality of pieces of curved surface data with one another;

FIG. 14 illustrates an example of a flowchart of a process of calculating DMU-based data from a solid model of a harness;

FIG. 15 is a diagram illustrating an example of a first section of a harness according to an embodiment which is prepared by combining a plurality of pieces of curved surface data with one another;

FIG. 16 is a diagram illustrating an example of a second section of the harness according to the embodiment which is prepared by combining a plurality of pieces of curved surface data with one another;

FIG. 17 is a diagram illustrating an example of a flat harness;

FIG. 18 illustrates an example of a flowchart of a process of calculating data of a flexible body model which may be simulated in DMU from a rigid body model of a flat harness;

FIG. 19 is a diagram illustrating an example of normal lines of surface data of a flat harness;

FIG. 20 illustrates an example of a flowchart of a process of calculating a polyline used when a flat cable is to be designed;

FIG. 21 is a diagram illustrating an example of a solid model of a harness which is prepared using polygons and is quadrilateral in sectional shape; and

FIG. 22 is an enlarged diagram illustrating an example of a harness which is prepared using polygons and is quadrilateral in sectional shape.

### DESCRIPTION OF EMBODIMENTS

Next, preferred embodiments will be described with reference to the accompanying drawings.

(1) Three-Dimensional CAD Device of Embodiment

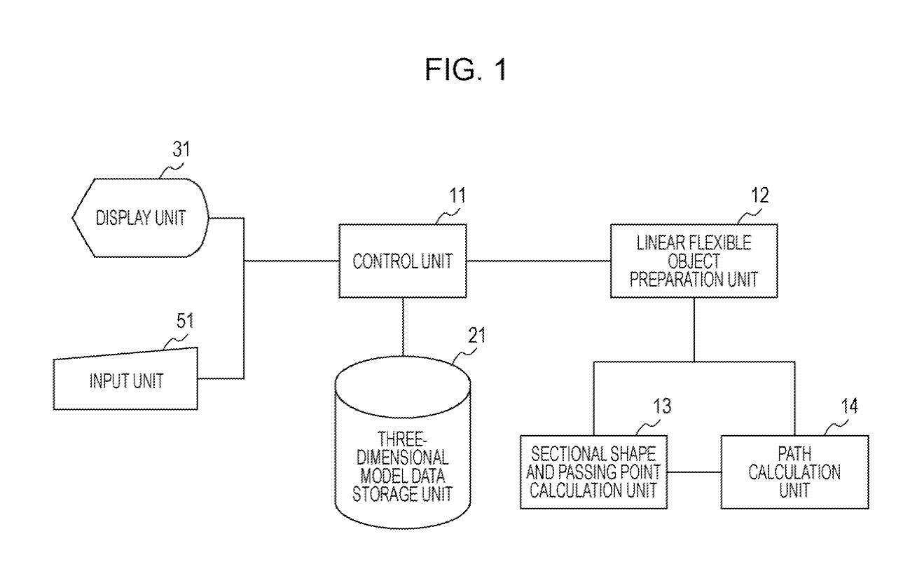

FIG. 1 is a functional block diagram illustrating an example of a three-dimensional CAD device according to an embodiment.

The three-dimensional CAD device includes a control unit 11, a three-dimensional model data storage unit 21, a linear flexible object preparation unit 12, a sectional shape and passing point calculation unit 13, and a path calculation unit 14. In some cases, the three-dimensional CAD device may also include a display unit 31 and an input unit 51.

The control unit 11 controls the entire of the three-dimensional CAD device.

The three-dimensional model data storage unit 21 stores shape data of a three-dimensional model of a designing object device. The designing object device (hereinafter, simply referred to as a product as the case may be) is a device which is an object to be designed and simulated in a virtual three-dimensional space prepared with the aid of three-dimensional CAD and is, for example, an industrial product. It is supposed that the designing object device according to the embodiment includes a plurality of components. The three-dimensional model data storage unit 21 also stores shape data of the plurality of components included in the designing object device. It is supposed that the plurality of components included in the designing object device according to the embodiment include linear flexible objects.

The linear flexible object preparation unit 12 prepares data (hereinafter, referred to as a flexible body model) used for simulating the operation of each linear flexible object from data (hereinafter, referred to as a rigid body model) used for expressing the linear flexible object. In the embodiment, it is supposed that the rigid body model of the linear flexible object is used when it is expressed in the form of a solid model and the flexible body model of the linear flexible object is used when it is simulated in DMU.

The sectional shape and passing point calculation unit 13 executes a process of specifying sections of the linear flexible object from the rigid body model of the linear flexible object and a process of determining reference positions on the specified sections, in a process of preparing the flexible body model of the linear flexible object which is executed using the linear flexible object preparation unit 12.

The path calculation unit 14 executes a process of specifying data forming a curved surface that connects together the sections of the linear flexible object calculated using the sectional shape and passing point calculation unit 13, a process of extracting a curve that connects together the sections from the specified data forming the curved surface, a process of specifying the normal direction of the extracted curve and a process of specifying a path that connects together the sections by shifting the curve in a direction opposite to the normal direction of the specified curved surface so as to fit between the reference positions of the sections, in the process of preparing the flexible body model of the linear flexible object which is executed using the linear flexible object preparation unit 12.

The linear flexible object preparation unit 12 executes a process of specifying the flexible body model of the linear flexible object from the shapes of the sections and the reference positions specified using the sectional shape and passing point calculation unit 13 and the path specified using the path calculation unit 14.

The linear flexible object preparation unit 12, the sectional shape and passing point calculation unit 13 and the path calculation unit 14 configure the flexible body model from the rigid body model of the linear flexible object of the three-dimensional model that the three-dimensional model data storage unit 21 holds so as to allow dynamic verification of the linear flexible object.

The display unit 31 displays the three-dimensional model. The input unit 51 accepts an instruction which is given from a user to the three-dimensional CAD device. The input unit 51 accepts, for example, an instruction to select the rigid body model of the linear flexible object from data on components included in the designing object device from the user and sends the control unit 11 the instruction. The control unit 11 specifies the rigid body model selection of which has been instructed in the instruction received from the input unit 51 from the three-dimensional model data stored in the three-dimensional model data storage unit 21. The linear flexible object preparation unit 12, the sectional shape and passing point calculation unit 13 and the path calculation unit 14 calculate the flexible body model of the linear flexible object from the rigid body model of the specified component.

Incidentally, since the linear flexible object has a characteristic shape, the control unit 11 is also allowed to specify component data of the linear flexible object by searching three-dimensional model data of a component having a characteristic shape from three-dimensional model data on components included in a product that the three-dimensional model data storage unit 21 stores.

In addition, in the case that attribute information such as the name and identification information of each component is included in each component data, it is also allowed to specify the component data of the linear flexible object utilizing the attribute information.

In addition, the user is allowed to select one linear flexible object to be processed in the rigid body modes displayed on the display unit 31 by designating it using the input unit 51.

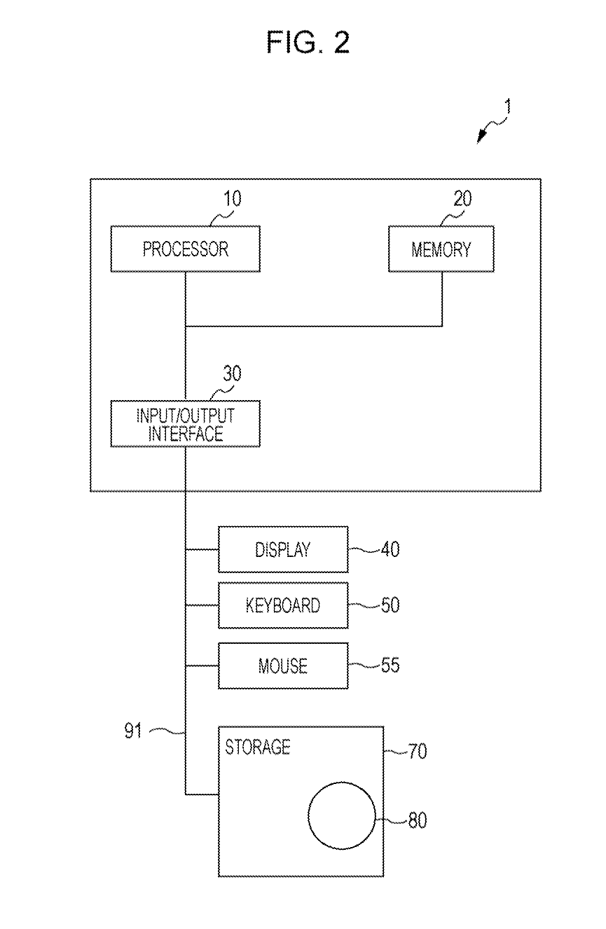

FIG. 2 is a diagram illustrating an example of a hardware configuration of a computer system (a three-dimensional CAD device) for implementing the three-dimensional CAD device according to one embodiment. The three-dimensional CAD device 1 according to the embodiment illustrated in FIG. 2 is, for example, a personal computer. The three-dimensional CAD device 1 is a device which is allowed to execute a drafting process of drafting a virtual three-dimensional shape and a three-dimensional simulation process of simulating an actual physical phenomenon that a virtual three-dimensional shape which is configured by execution of an arithmetic operation using a computer may encounter by executing an arithmetic operation.

The three-dimensional CAD device 1 illustrated in FIG. 2 includes a processor (a CPU) 10, a memory (a ROM, a RAM, an HDD or the like) 20, an input/output interface 30 which are connected with one another via a bus 90. The input/output interface 30 is connected with a display (for example, a CRT, an LCD, a PDP or the like) 40, a keyboard 50, a mouse 55 and a storage unit 70 via a bus.

The memory 20 stores a three-dimensional CAD program and various pieces of data relating to models of a designing object device to be designed with the aid of three-dimensional CAD and also functions as a working memory that the processor 10 uses in execution of the three-dimensional CAD program. In the embodiment, the memory 20 corresponds to the three-dimensional model data storage unit 21 illustrated in FIG. 1.

The processor (the CPU) 10 controls the entire process of the three-dimensional CAD device 1. The processor 10 executes the three-dimensional CAD program stored in the memory 20 to function as the linear flexible object preparation unit 12, the sectional shape and passing point calculation unit 13 and the path calculation unit 14 illustrated in FIG. 1.

The storage 70 reads out the three-dimensional CAD program which is stored in a computer readable recording medium 80. The recording medium 80 includes various computer readable media such as a flexible disk, a CD-ROM, a DVD, a magnetic disk, an optical disk, a magnet-optical disk, an ID card, a ROM cartridge, a magnetic tape, a punched card, a printed matter on which a code such as a bar code or the like is printed and the like. The storage 70 is also allowed to store in advance component models included in a product model in a library. The computer system (that is, the three-dimensional CAD device) 1 reads the three-dimensional CAD program which is stored, for example, in the recording medium 80 and is read out using the storage 70 into the memory 20 via the input/output interface 30.

The designing object device to be processed using the three-dimensional CAD device 1 according to the embodiment includes a plurality of components. Linear flexible objects are included in components of a product. As examples of the linear flexible object, a cable, a wire harness, a thread, a string, a code and the like may be given. In the embodiment, description will be made by giving a wire harness as an example of a linear component. A wire harness is a bundle of a plurality of wires of lengths and shapes that allow ready fitting of the harness to a product concerned.

(2) Wire Harness

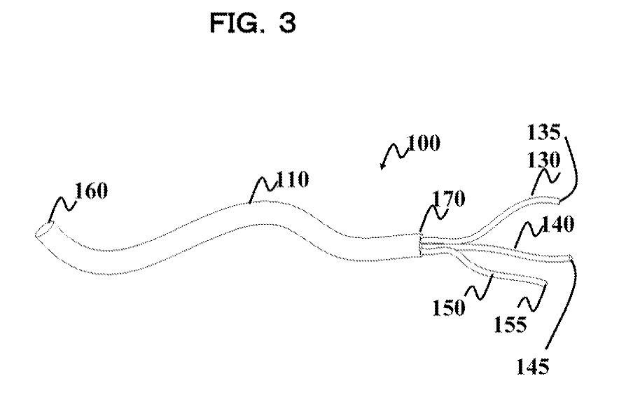

FIG. 3 is a diagram illustrating an example of a wire harness (hereinafter, simply referred to as a harness as the case may be) according to the embodiment. A wire harness 100 is a linear flexible object. The external form of the wire harness includes sections of the wire harness corresponding to terminal parts or branched parts and a cover surface (a side surface) of the wire harness corresponding to a wire part. In the harness 100 to be designed with the aid of three-dimensional CAD, both end sections to be connected with other components included in the product are planes. The side surface disposed between the both end sections is connected between them in the form of a plane or a curved surface. Since the harness is a combination of a plurality of cables, it is supposed that the both ends of each cable included in the harness to be designed with the aid of three-dimensional CAD are planes. The position where the harness is branched into the plurality cables may be thought to be an end of each of the plurality of cables. Thus, it is supposed that the position of the branched part is expressed in the form of a plane.

The harness 100 illustrated in FIG. 3 is of the shape including one wire 110 which is thick in a longitudinal direction and three thin wires 130, 140 and 150 which are branched from the wire 110. Ends of the wire 110 are sections 160 and 170. One ends of the wires 130, 140 and 150 corresponds to one end of the harness 100 and are respectively sections 135, 145 and 155. The other ends of the wires 130, 140 and 150 constitute the section 170 of the wire 110. In the embodiment, it is supposed that when the wire is made straight, normal directions of the sections 160, 170, 135, 145 and 155 of the harness 100 coincide with the longitudinal direction of the wire.

In the case that a product is to be displayed in the form of a solid model of the three-dimensional CAD device, in general, a rigid body model of a three-dimensional model is expressed in polygon data that a plurality of polygons approximate the surface shape of the three-dimensional model or in surface data including a plurality of planes and a plurality of curved surfaces that express the surface shape of the three-dimensional model.

First, an example in which the rigid body model is expressed in the polygon data will be described.

(3) Harness Prepared on Polygon Data

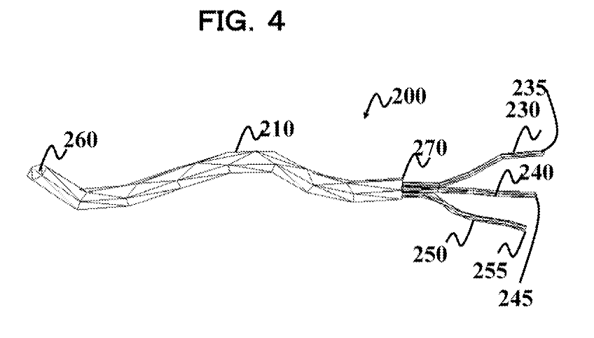

FIG. 4 is a diagram illustrating an example of a solid model of the harness 100 according to the embodiment which has been prepared on the basis of the polygon data.

Each polygon indicates each polygonal form (supposed to be a triangle in the embodiment) which is used in expression of the surface of the rigid body model. The polygon data indicates a set of a plurality of polygons that express the rigid body model.

The shape of a harness 200 illustrated in FIG. 4 corresponds to the shape of the harness 100 illustrated in FIG. 3. The harness 200 is configured by closely covering the surface of the harness 200 with the plurality of polygons.

Since the harness 200 is configured by combining the plurality of polygons with one another, it may be difficult for the harness 200 to accurately express a circle and a curved surface of the harness 100. The harness 200 is prepared such that an error in shape between the harnesses 100 and 200 is held within a fixed range which has been defined in advance.

Polygon groups 260, 270, 235, 245 and 255 that express sections of the harness are plane and respectively correspond to the sections 160, 170, 135, 145 and 155 of the harness 100. Polygon groups 210, 230, 240 and 250 that express the side surfaces of the harness exhibit cylindrical curved surfaces and respectively correspond to the wires 110, 130, 140 and 150 of the harness 100.

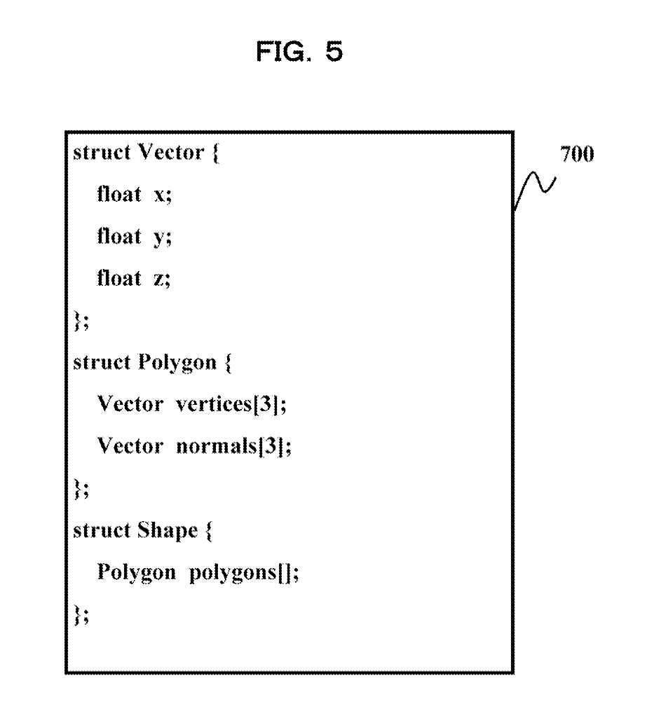

FIG. 5 is a diagram illustrating an example of a data format of the solid model of the harness of the embodiment.

In three-dimensional CAD, the harness is prepared by defining the shape using sectional shapes and loci. The solid model in three-dimensional CAD is displayed in the form of shape data. The shape data includes a plurality of polygons. Each polygon includes three vertex coordinates and normal vectors at respective vertices. Normal vectors are defined for respective polygons, respective vertices of respective polygons, or respective polygons and respective vertices of respective polygons. A numeral 700 in FIG. 5 is an example of a code that defines each polygon.

(4) Process of Calculating DMU-Based Data

Next, a process of preparing a flexible body model which may be used in DMU-based simulation will be described with respect to a rigid body model of a three-dimensional model of a component that the three-dimensional CAD device or a user has selected from the rigid body models of the three-dimensional models which are stored in the three-dimensional model data storage unit 21.

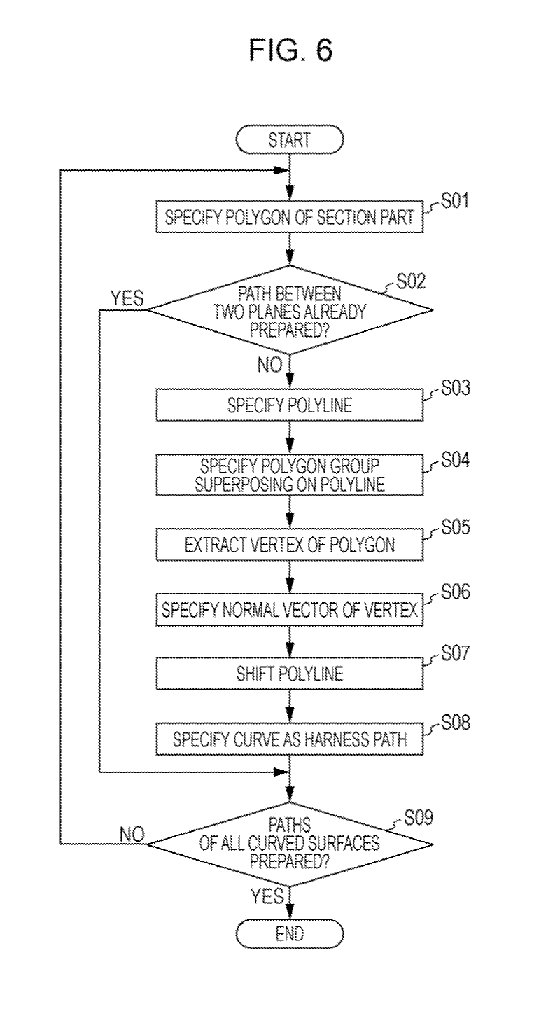

FIG. 6 illustrates an example of a flowchart of a process of calculating DMU-based data from a solid model of a harness which is expressed with polygons.

The sectional shape and passing point calculation unit 13 specifies each polygon group that displays each sectional shape of the harness 200 from polygon data indicating a three-dimensional rigid body model of a processing object component (S01). In the embodiment, it is supposed that a section is a plane. When the direction of the normal vector included in one polygon is not coincident with the direction of the normal vector included in an adjacent polygon, the sectional shape and passing point calculation unit 13 judges that these two polygons do not form a plane. On the other hand, when the direction of the normal vector included in one polygon is coincident with the direction of the normal vector included in an adjacent polygon, the sectional shape and passing point calculation unit 13 judges that these two polygons form a plane. The sectional shape and passing point calculation unit 13 is allowed to detect the polygon group that displays the sectional shape by detecting all polygons that form one plane. The sectional shape and passing point calculation unit 13 repetitively executes the above mentioned processes until all the polygon groups each forming a plane are processed and detects all the planes included in the harness 200. As a result, the sectional shape and passing point calculation unit 13 detects the shape of each plane in accordance with a combination of the polygon groups and detects the orientation of each plane in accordance with the normal direction of each polygon.

In the embodiment, the sectional shape and passing point calculation unit 13 specifies the position of the center of each plane and stores it as the position of a reference position (a passing point). The passing point is information indicating the position where path information of the harness used in DMU passes and coordinates at a certain point on the path is coincident with the coordinates of a passing point in the three-dimensional space.

In addition, the sectional shape and passing point calculation unit 13 calculates a distance between the outer edge of each section of the harness and the center of each section, for example, from the coordinates of one vertex of the outer edge of each section of the harness and the coordinates of the center of each section of the harness.

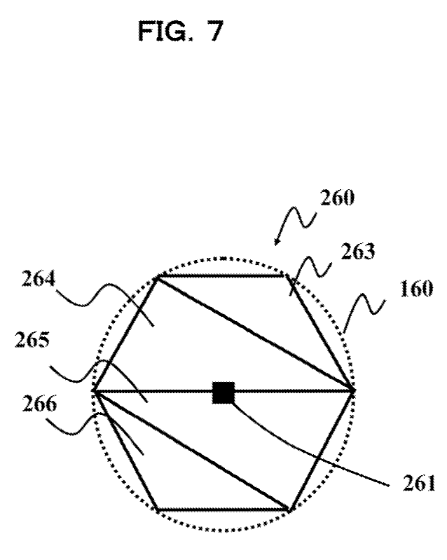

FIG. 7 is a diagram illustrating an example of a first section of a harness which is prepared with polygons.

The first section 260 includes a polygon group that displays the shape of the section 160 of the harness 100. That is, the first section 260 includes polygons 263, 264, 265 and 266. 261 is a passing point of the first section 260. In many cases, the section of the harness is made circular. Therefore, in the embodiment, the sectional shape and passing point calculation unit 13 sets the center of the section as the passing point. Incidentally, the passing point may be determined on the basis of another reference.

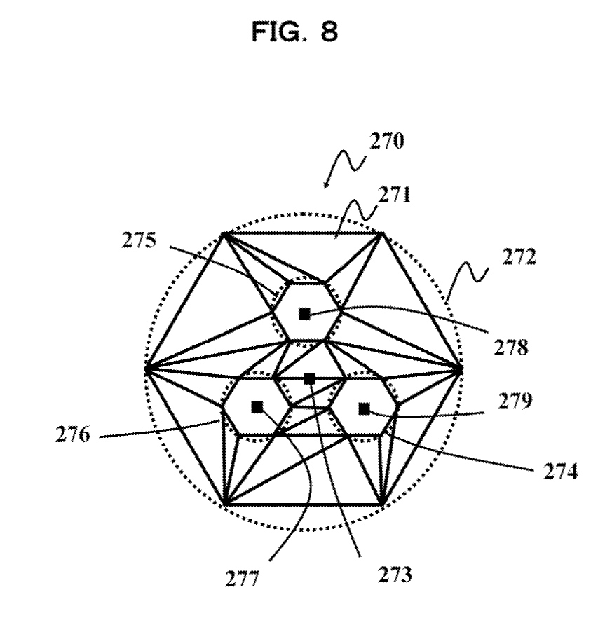

FIG. 8 is a diagram illustrating an example of a second section of the harness which is prepared with polygons.

A polygon group 270 that expresses the second section corresponds to the polygon group that displays the shape of the section 170 of the harness 100. 271 is one of polygons included in the polygon group 270 that expresses the second section. On the section 170 of the harness 100 that corresponds to the polygon group 270 that expresses the second section, the wire 110 is branched into three wires 130, 140 and 150. Thus, the polygon group 270 that expresses the second section forms a complicated shape that allows arrangement of these three wires 130, 140 and 150 and hence includes a larger number of polygons than the polygon group 260 that expresses the first section.

A dotted-line part 272 corresponds to an outer edge end of the section 170 of the harness 100. Dotted-line parts 274, 275 and 276 respectively correspond to the other ends of the wires 130, 140 and 150 of the harness 100. Since the other ends of the wires 130, 140 and 150 hide behind the surface of the harness in the example illustrated in FIG. 8, any polygon is not prepared. The section 170 of the harness 100 corresponds to ends of a plurality of wires. Therefore, an end of a plane and a boundary such as a hole or the like in the plane leads to a wire. Thus, it may be estimated that a polygon which is adjacent to a polygon corresponding to the boundary on the plane and does not form a plane is a polygon that expresses a wire.

277, 278 and 279 are passing points for the three wires 130, 140 and 150 of the harness 100. In many cases, the sectional shape of a wire is circular. Thus, in the embodiment, when the boundary such as the hole or the like in the plane is circular, the sectional shape and passing point calculation unit 13 sets a point which is separated from vertices of respective polygons that define a hole with equal distances and is on an extension from the plane as a passing point. Incidentally, the passing point may be determined on the basis of another reference.

Description will be continued returning to the explanation of the flowchart in FIG. 6. Next, the path calculation unit 14 judges whether a path between the respective planes that the sectional shape and passing point calculation unit 13 has acquired has already been prepared (S02). When the path has already been prepared (S02: Yes), the path calculation unit 14 executes processes at S08 and succeeding steps. On the other hand, when the path is not yet prepared (S02: No), the path calculation unit 14 executes processes at S03 and succeeding steps.

(5) Polyline Specifying Process

Next, the path calculation unit 14 specifies a polyline that connects together the respective planes (S03). The path calculation unit 14 specifies the polyline between the sections by using vertices and sides of polygon groups that express wire parts each connecting together each two of a plurality of sections that the sectional shape and passing point calculation unit 13 has extracted at S01.

The path calculation unit 14 specifies the polyline by using, for example, A-star search algorithm (A* search algorithm), Dijkstra's algorithm or the like. In the following, a process using A* search algorithm will be described.

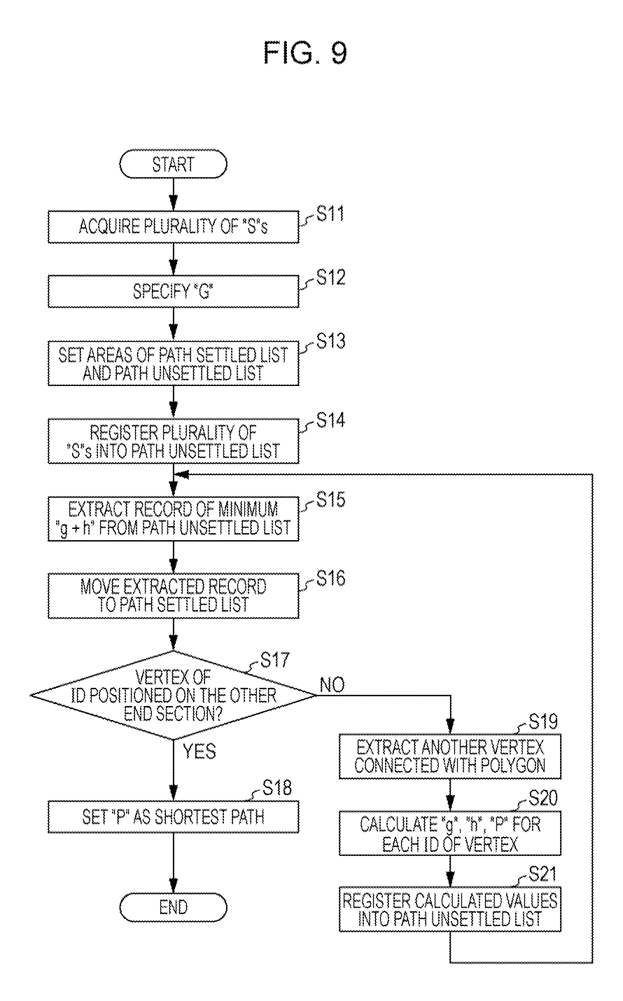

FIG. 9 illustrates an example of a flowchart of a polyline specifying process.

In A* search algorithm, the following parameters and lists are used. It is supposed that “S” is a vertex of each of polygons that form an outer edge end of one section. Incidentally, a plurality of “S”s are present. It is supposed that “G” is the coordinates of the center of the other section. A path settled list for storing information of vertices included in a shortest path and a path unsettled list for storing information on vertices used for calculating the shortest path are prepared.

Each record in the path settled list and the path unsettled list includes data of “ID”, “g”, “h” and “P”. “ID” is information used for identifying each vertex, “g” is a distance from “S” to a vertex (hereinafter, referred to as a vertex concerned) corresponding to “ID” in the record, “h” is a distance from the vertex concerned to “G”, and “P” is a path from “S” to the vertex concerned.

The path calculation unit 14 acquires a plurality of “S”s (S11). For example, the path calculation unit 14 executes the process starting from a section positioned at an end of the harness 200. The path calculation unit 14 specifies “G” (S12). The path calculation unit 14 sets areas where the path settled list and the path unsettled list are stored (S13). The path calculation unit 14 registers the plurality of “S”s acquired at S11 into the path unsettled list (S14). The path calculation unit 14 registers “g” into the path unsettled list as zero (0) and also registers “h” into the path unsettled list as a one-line distance from each “S” to “G”.

The path calculation unit 14 extracts a record that a value “g+h” is minimum from the path unsettled list (S15). The path calculation unit 14 moves the extracted record from the path unsettled list to the path settled list (S16).

The path calculation unit 14 judges whether the vertex of “ID” included in the extracted record is a vertex positioned on the other section (S17). When the vertex of “ID” included in the record is the vertex positioned on the other section (S17: Yes), the path calculation unit 14 sets “P” included in the extracted record as a shortest path (S18) and terminates execution of the process.

On the other hand, when the vertex of “ID” included in the record is not the vertex positioned on the other section (S17: No), the path calculation unit 14 extracts another vertex which is directly connected with the vertex of “ID” included in the record via a side of a polygon (S19). However, the path calculation unit 14 excludes a vertex of “ID” that has already been registered into the path settled list.

The path calculation unit 14 calculates the values “g”, “h” and “P” for each “ID” of each extracted vertex (S20). The path calculation unit 14 registers the values “g”, “h” and “P” calculated at S20 into the path unsettled list in correspondence with “ID” (S21). When the record of “ID” of the vertex extracted at S19 is already registered, the path calculation unit 14 selects one record that the value “g” is smaller than that in another record and registers it into the list. Then, the path calculation unit 14 executes again the process at S15.

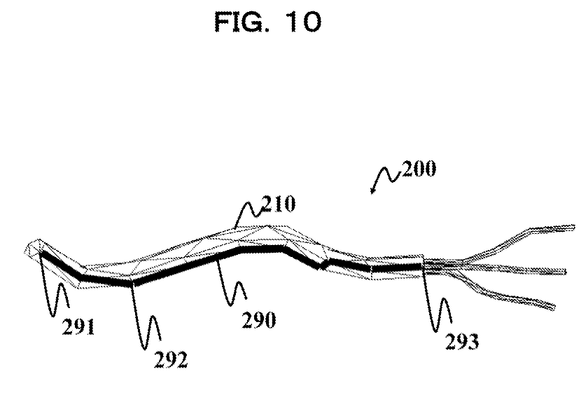

FIG. 10 is a diagram illustrating an example of a polyline that connects together sections of the harness 200. In FIG. 10, 290 is a polyline of the wire 210 of the harness 200. The polyline 290 is a line that passes sides and vertices of some polygons in a polygon group used to display the wire 210. 291 is a vertex which will be the first object for polyine search. The vertex 291 is on the outer edge of one polygon that expresses one section. 292 is one of vertices of one polygon that expresses the side surface of the harness and is a vertex on the polyline. 293 is a vertex of one polygon positioned on the outer edge of the other section of the polyline and is positioned on one end of the polyline 290. Incidentally, in the embodiment, it is supposed that the normal vector of each polygon is oriented from the inside of the rigid body model of each component toward its outside.

Next, the path calculation unit 14 specifies a path that passes the center of the harness which is a part of the flexible body model from the polyline specified at S03. Since the polyline specified at S03 is specified from the polygon that expresses the side surface of the harness, it runs along the surface of the harness. The path calculation unit 14 specifies the path that passes the center of the harness by shifting the polyline acquired at S03 to the center of the harness.

In the embodiment, the path calculation unit 14 shifts the polyline to the center of the harness by utilizing the vector of the vertex of each polygon that the polyline passes. The sectional shape of the harness 100 is circular. In a circular harness of the type as mentioned above, the center of the harness 100 is situated at the center of the circular section. Therefore, a distance from the outer edge of the section of the harness, that is, from the surface of the side surface of the harness to the center of the harness corresponds to the radius of the section. In addition, the center of the harness 100 is oriented in a direction opposite to the normal line of the side surface at any point on the side surface of the harness 100. In a polyline of a wire part of the circular harness, a direction from the polyline to the center of the harness coincides with a direction opposite to the normal vector of the vertex of each polygon that the polyline passes.

Therefore, the path calculation unit 14 specifies a polygon group that superposes on the specified polyline (S04). The path calculation unit 14 extracts each vertex of each polygon included in the specified polygon group (S05). The path calculation unit 14 specifies the normal vector of each specified vertex (S06). Owing to the above mentioned operations, the path calculation unit 14 is allowed to specify a direction in which each vertex that the polyline passes is directed in order to shift it to the center of the harness.

Incidentally, in the circular harness, since the normal vector of the vertex of each polygon used to display the wire is oriented opposite to the center of the harness, no limitation is set on specification of the polyline. Therefore, the path calculation unit 14 needs only specify a shortest path running from one section to the other section as the polyline.

The path calculation unit 14 shifts each vertex that the polyline passes in a direction opposite to the orientation of the normal vector by the amount corresponding to the distance from the outer edge of the section to the center (the passing point) of the section that the sectional shape and passing point calculation unit has calculated (S07) to specify the polyline that passes the center of the harness.

The path calculation unit 14 calculates a curve that approximates the specified polyline that passes the center of the harness to specify it as the path of the harness (S08)

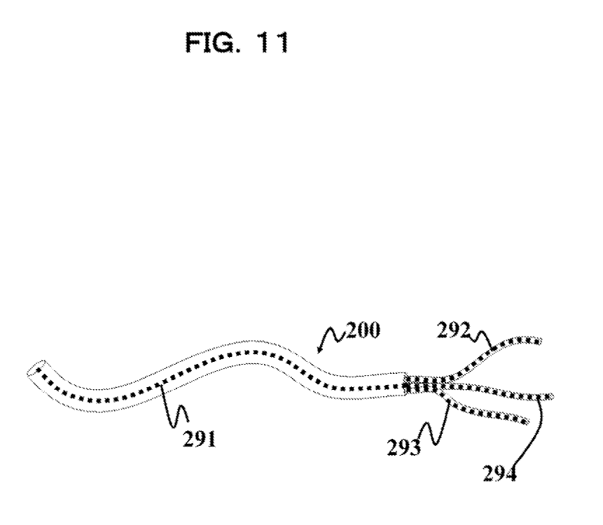

FIG. 11 is a diagram illustrating an example of paths that connect together the passing points on the respective sections of the harness, in which 295, 296, 297 and 298 are extracted paths. Each path passes the center of the harness. In addition, each path passes the center of each section. Each path passes the center of each section which is made in correspondence with each cable in the section of a part where the wire is branched.

The path calculation unit 14 stores the path of the harness specified at S08.

The path calculation unit 14 judges whether all the wires of the harness have been processed (S09). The path calculation unit 14 judges whether all the wires of the harness have been processed, for example, by judging whether a path that connects together the sections is present. In the case that all the wires are not yet processed (S09: No), the path calculation unit 14 executes the processes at S01 and succeeding steps. In the case that all the wires have been processed (S09: Yes), the path calculation unit 14 terminates execution of the process.

The linear flexible object preparation unit 12 constructs a flexible body model of harness data to be used in DMU-based simulation using the sectional shape and the passing points of the harness that the sectional shape and passing point calculation unit 13 has calculated and the paths that the path calculation unit 14 has calculated.

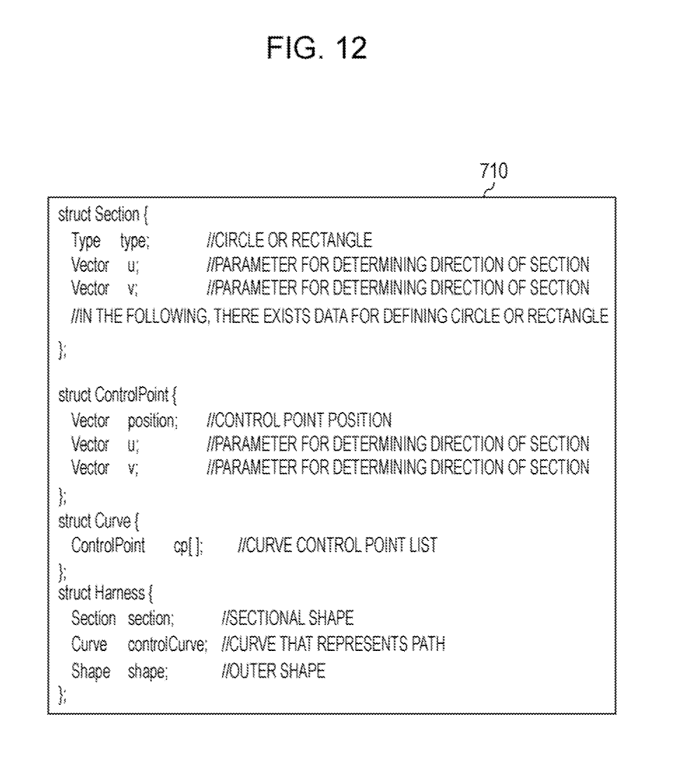

FIG. 12 is a diagram illustrating an example of a DMU-based data format of the harness according to the embodiment. The flexible body model of the harness which is used in the DMU-based simulation includes the sectional shape of the harness, control points on a curve that represents a path between sections, the positions of the control points, orientations of the sections at the control points and an outer shape to be displayed on a screen. The sectional shape of the harness includes information used to specify the sectional shape such as, for example, a circle, a rectangle or the like and the orientation of each section.

The display unit 31 displays harness data that the linear flexible object preparation unit 12 has constructed, the input unit 51 receives an instruction from a user and the control unit 11 executes a verifying process in accordance with the received instruction. As a result, the control unit 11 is allowed to perform dynamic verification in DMU by using harness data of an object which has been defined as a flexible object on the basis of the specified sectional shape, passing points and paths.

(6) Harness Prepared by Combination of Plurality of Pieces of Curved Surface Data

Next, a process of acquiring flexible body model data used in DMU from a solid model prepared on the basis of surface data including pluralities of planes and curved surfaces that represent the surface shape of a three-dimensional model will be described.

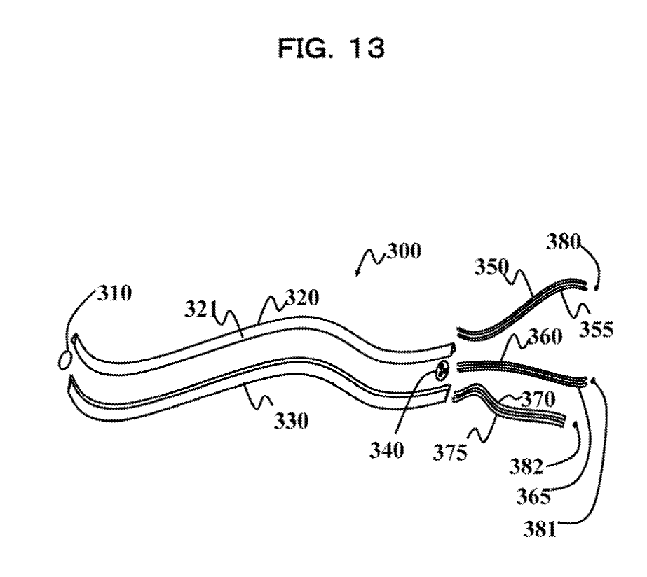

FIG. 13 illustrates an example of the surface data that represents the shape of the harness of the embodiment which has been prepared by combining a plurality of pieces of curved surface data with one another. Each surface data according to the embodiment includes information defining whether the shape is a plane or a curved surface. The surface data also includes information of a border line. A harness 300 in FIG. 13 corresponds to the harness 100 in FIG. 3. The harness 300 includes a plurality of pieces of plane shape data and a plurality of pieces of curved surface shape data. The harness 300 includes circular sections 310, 380, 381 and 382 positioned on ends of the harness and a circular section 340 positioned on a branching part of the harness and having holes formed therein. The sectional shape of the harness according to the embodiment represents the outline of a plane that shapes an end surface or a branch surface. In the embodiment, it is supposed that the passing point of the harness is at the center of the sectional shape.

The side surface (the cover surface) of the harness includes some surfaces prepared per block of the harness. Curved surfaces 320 and 330 that represent the side surface (the cover surface) of the harness correspond to the wire 110 of the harness 100, curved surfaces 350 and 355 correspond to the wire 130 of the harness 100, curved surfaces 360 and 365 correspond to the wire 140 of the harness 100, and curved surfaces 370 and 375 correspond to the wire 130 of the harness 100.

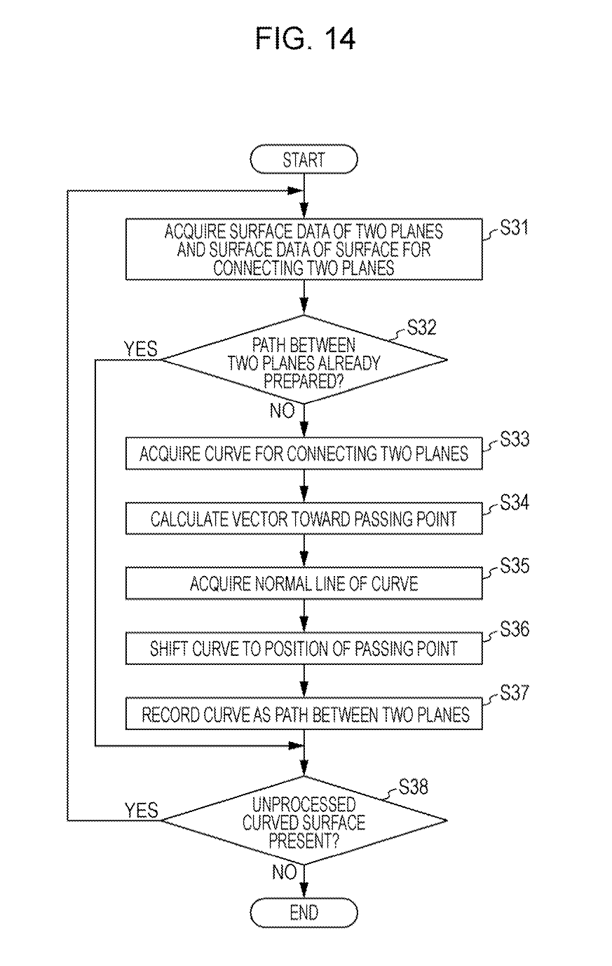

FIG. 14 illustrates an example of a flowchart of a process of calculating data for DMU from a solid model of a harness.

The sectional shape and passing point calculation unit 13 executes the following processes on a selected component.

The sectional shape and passing point calculation unit 13 reads surface data on the selected component out of the three-dimensional model data storage unit 21. The sectional shape and passing point calculation unit 13 extracts surface data of two planes and surface data of a surface that connects together the two planes from the read-out surface data (S31). It is supposed that the sectional shape and passing point calculation unit 13 is allowed to judge whether the surface concerned is a plane or a curved surface and is allowed to acquire surface data of a surface which is adjacent to the above mentioned surface data.

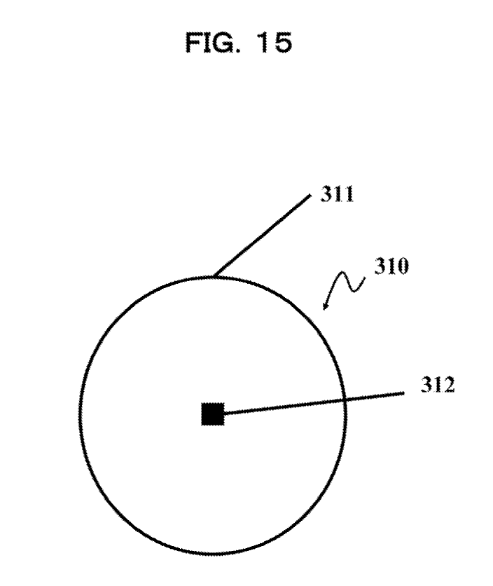

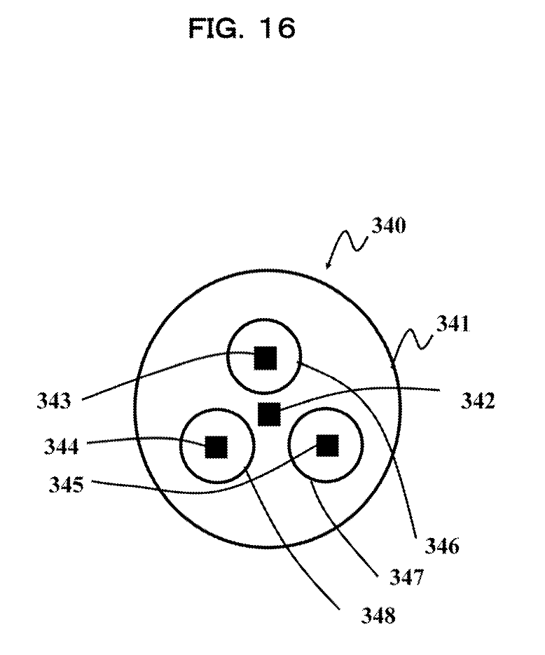

The sectional shape and passing point calculation unit 13 extracts plane surface data from a plurality of pieces of surface data for expressing the harness. In the example in FIG. 13, the sections 310, 340, 380, 381 and 382 correspond to the above plane surface data. FIG. 15 is a diagram illustrating an example of a first section of the harness according to the embodiment which is prepared by combining a plurality of pieces of curved surface data. It is supposed that the section 310 which is the first section is circular. In the embodiment, it is supposed that the passing point is arranged at the center of the section. Thus, a distance from an outer edge end 311 of the section to the center 312 of the section corresponds to the radius of the circle of the first section. FIG. 16 is a diagram illustrating an example of a second section of the harness according to the embodiment which is prepared by combining a plurality of pieces of curved surface data. It is supposed that the section 340 which is the second section is circular. The section 340 corresponds to a place where one wire 110 is branched into the three wires 130, 140 and 150. In the embodiment, the passing point corresponding to that of the wire 110 is arranged at the center of the section 340. 346, 347 and 348 are parts with which the wires 130, 140 and 150 are respectively connected. The parts 346, 347 and 348 with which the wires 130, 140 and 150 are connected respectively define holes. A distance from an outer edge end 341 of the section to a center 342 of the section corresponds to the radius of the circle of the second section. A distance from an edge of the hole 346 to a center 343 of the hole 346 corresponds to the radius of the hole 346. Likewise, a distance from an edge of the hole 347 to a center 345 of the hole 347 corresponds to the radius of the hole 347 and a distance from an edge of the hole 348 to a center 344 of the hole 348 corresponds to the radius of the hole 348.

The sectional shape and passing point calculation unit 13 calculates the sectional shape of the surface data on the plane and the passing point which is the center of the section. Incidentally, the sectional shape and passing point calculation unit 13 specifies the center of a section of the shape other than a circular by using, for example, a method of specifying the center of gravity of a plane.

The path calculation unit 14 judges whether a path between the acquired two planes has already been prepared (S32). When the path has already been prepared (S32: Yes), the path calculation unit 14 executes the processes at S38 and succeeding steps. When the path is not yet prepared (S32: No), the path calculation unit 14 executes the processes at S33 and succeeding steps.

The path calculation unit 14 extracts a curve that connects together two planes that passes on the surface that connects together the two planes and has been extracted at S31 (S33). The curve extracted at S33 serves as a reference for calculating a curve representing a path. Incidentally, the path calculation unit 14 is allowed to acquire the curve that connects together the sections from the outer edge of the surface data. For example, 321 which is the outer edge of the surface data 320 in FIG. 13 is a curve that connects the section 310 with the section 340.

The path calculation unit 14 calculates a vector directing from a point on the border line of each of the planes that the curve extracted at S33 connects together to the passing point that the sectional shape and passing point calculation unit 33 has calculated (S34). Incidentally, in the embodiment, the vector to be calculated at S34 is not an absolute vector in a three-dimensional simulation space and is calculated using the normal line of the surface representing the side surface of the harness as a reference. It may become possible to correctly prepare a path that passes the center of the harness even from a curved side surface by using the normal line of the surface representing the side surface of the harness as a reference. In the embodiment, a distance between the center of the section and the side surface of the harness corresponds to the length of the radius of the section.

The path calculation unit 14 acquires the normal line of the curve which has been extracted at S33 (S35). Since the curve acquired at S33 is a curve in a three-dimensional space, the normal line differs for different position. Therefore, in the embodiment, the path calculation unit 14 discretely calculates the normal line by utilizing the curvature of the curve or the like.

The path calculation unit 14 shifts the curve extracted at S33 by the amount corresponding to the vector which has been calculated at S34 by using the normal line acquired at S35 as a reference (S36). The curve extracted at S33 is a curve that passes the surface of the harness 300. A curve that passes the center of the wire of the harness 300 is desirable as a path of the harness 300. Thus, the curve that passes the center of the harness is calculated by shifting the curve to the center of the section using the normal line of the curve as a reference.

The path calculation unit 14 records the curve calculated at S36 as a path between the two planes acquired at S31, that is, a path of the harness (S37).

The path calculation unit 14 judges whether an unprocessed curved surface is present (S38). When an unprocessed curved surface is present (S38: Yes), the path calculation unit 14 returns to S31 and continuously executes the process. When any unprocessed curved surface is not present (S38: No), that is, all the curved surfaces of the components of the harness have been processed, the path calculation unit 14 terminates execution of the process.

The linear flexible object preparation unit 12 prepares a flexible body model of the harness 300 which may be simulated in DMU by using the sectional shape and the passing point that the sectional shape and passing point calculation unit 13 has calculated and the path that the path calculation unit 14 has calculated.

(7) Harness of Polygonal Sectional Shape

Next, a case in which the sectional shape of a harness is polygonal will be described. As an example of the harness of the polygonal section shape, a flat harness of a square sectional shape may be given.

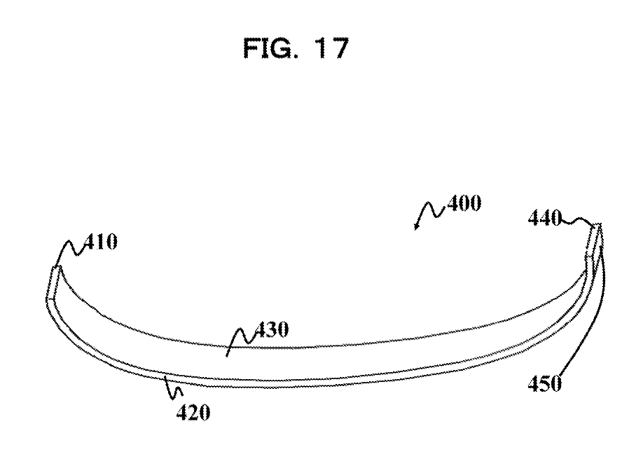

FIG. 17 is a diagram illustrating an example of a flat harness. It is supposed that a flat harness 400 according to the embodiment has rectangular plane sections and side surfaces when the harness is extended. Therefore, since it is defined that the shapes of both sections (end surfaces) in surface data of the flat harness are not different from each other, they both form rectangular planes. On the other hand, since the shapes of the side surfaces in the surface data of the flat harness may be different from one another, each of them may form any one of a rectangular plane, a plane and a curved surface. The surface data of the flat harness 400 includes sections 410 and 440, a first wide side surface 430, a side surface 450 in opposition to the side surface 430, a second narrow side surface 420 and data on a side surface in opposition to the side surface 420.

Next, a data calculating process to be executed when the sectional shape of the harness concerned is square will be described.

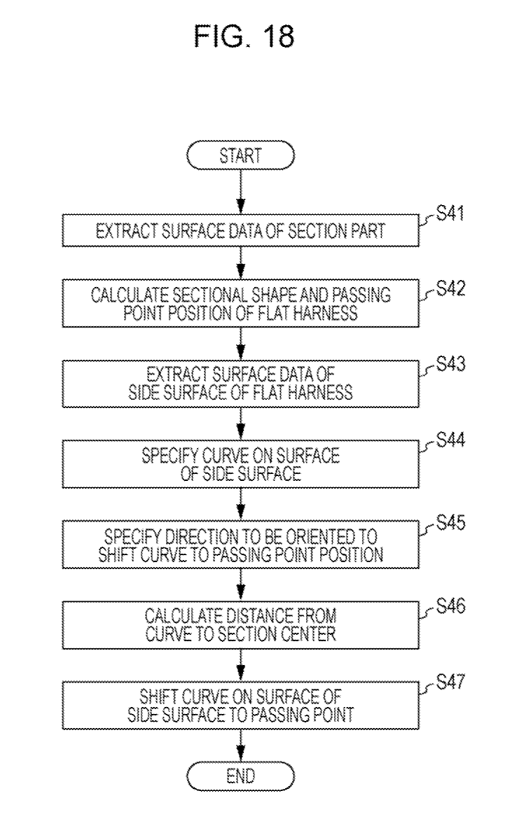

FIG. 18 illustrates an example of a flowchart of a process of calculating data of a flexible body model which may be simulated in DMU from a rigid body model of a flat harness.

The sectional shape and passing point calculation unit 13 extracts surface data on sectional parts from a plurality of pieces of surface data included in shape data of a three-dimensional model of a selected flat cable component (S41). Incidentally, in some cases, a certain side surface of the flat harness may be plane unlike a round harness which is circular in section. Thus, in some cases, when surface data is extracted simply by giving that the section is plane as the condition of the section concerned, the sectional shape and passing point calculation unit 13 may extract surface data on both sections and side surfaces. Therefore, for example, when the side surfaces have been detected, the sectional shape and passing point calculation unit 13 extracts planes that form end surfaces with certainty by selecting one pair of surfaces of smaller areas. Incidentally, in the case that planes have been detected on the basis of, for example, adjacent pieces of surface data, the sectional shape and passing point calculation unit 13 judges that one section and one side surface have been detected.

Next, the sectional shape and passing point calculation unit 13 calculates the sectional shape and the passing point position of the flat harness from the surface data on the sections extracted at S41 (S42). The sectional shape of the flat harness corresponds to the outline of the plane extracted at S41. In the embodiment, it is supposed that the center of the sectional shape of the flat harness is set as the passing point. Since the sectional shape of the flat harness according to the embodiment is rectangular, the sectional shape and passing point calculation unit 13 is allowed to calculate the passing point by obtaining a point of intersection of two diagonal lines. In addition, the sectional shape and passing point calculation unit 13 is also allowed to set the position of the center of gravity of the shape of the section as the passing point.

Next, the path calculation unit 14 extracts surface data on side surfaces that connect together the sections of the flat harness extracted at S41 (S43). In the example in FIG. 17, the path calculation unit 14 extracts surface data on positions corresponding to the side surface 420, the side surface 430, the side surface 450 and the side surface 420.

The path calculation unit 14 specifies a curve on each side surface that connects together the sections of the flat harness and has the surface data extracted at S43 (S44). The path calculation unit 14 specifies the curve that connects together the sections of a flat cable from, for example, an outer edge of surface data of a part corresponding to each side surface, that is, each cover surface of the flat harness.

Next, the path calculation unit 14 specifies a direction in which the curve specified at S44 is oriented in order to shift it to the position of the passing point (S45).

In a round harness the section of which is circular, since the side surface is cylindrical and hence the normal line of a curved surface is oriented in a direction opposite to the center of a cylinder, the normal line of the curve may be uniquely determined. In the round harness, the path calculation unit 14 is allowed to calculate the curve that passes the center of the harness by shifting the curve in a direction opposite to that of the normal line of the surface data on the side surface by the amount corresponding to the radius of a circle that represents the sectional shape. On the other hand, one curve that defines the shape of one side surface of the flat harness defines the shapes of surface data on two adjacent side surfaces. Therefore, the orientation of the normal line differs for different surface to be used as a reference.

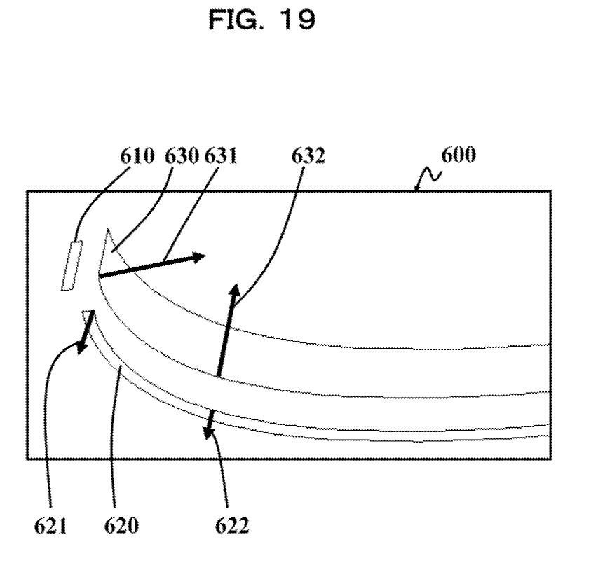

FIG. 19 is a diagram illustrating an example of normal lines of surface data of a flat harness. Shape data on a flat harness 600 includes a plurality of pieces of surface data. The flat harness 600 illustrated in FIG. 19 is data that the flat harness 400 in FIG. 17 is expressed in surface data and FIG. 19 is a partially enlarged diagram illustrating an example of the flat harness 400.

In the example in FIG. 19, a section 610, a first side surface 630, and a second side surface 620 are illustrated as surface data. Directions 631 and 632 represent normal lines of the first side surface 630. Directions 621 and 622 represent normal lines of the first side surface 620. Therefore, it may be difficult for the path calculation unit 14 to shift the curve on the side surface to the center of the section simply by shifting the curve in a direction opposite to that of the normal line of the side surface concerned.

Thus, in the embodiment, the path calculation unit 14 expresses a vector directing from a point on the border line of the plane to the passing point that the sectional shape and passing point calculation unit 13 has calculated by a composite vector of the normal line vector of the first side surface 630 with the normal line vector of the second side surface 620.

Supposing that V1 is the vector of the first side surface 630, V2 is the vector of the second side surface 620 and V0 is the vector oriented toward the center of the section 610, a relation V0=s*V1+t*V2 will be met. Thus, the path calculation unit 14 needs only calculate values of “s” and “t” that may meet the relation V0=s*V1+t*V2. The path calculation unit 14 specifies the direction in which the curve specified at S44 is oriented in order to shift it to the position of the passing point in the above mentioned manner.

Then, the sectional shape and passing point calculation unit 13 calculates a distance from a point that the curve on the outer edge of the section which has been specified at S44 passes to the center of the section (S46).

Next, the path calculation unit 14 shifts the curve specified at S44 to the position of the passing point (S47).

The three-dimensional CAD device executes the above mentioned processes between each two of all sections to prepare a flexible body model that allows simulation of the operation of a component used in DMU.

Next, an example of specifying data which may be simulated in DMU from a solid model in which a flat harness is expressed with polygons will be described.

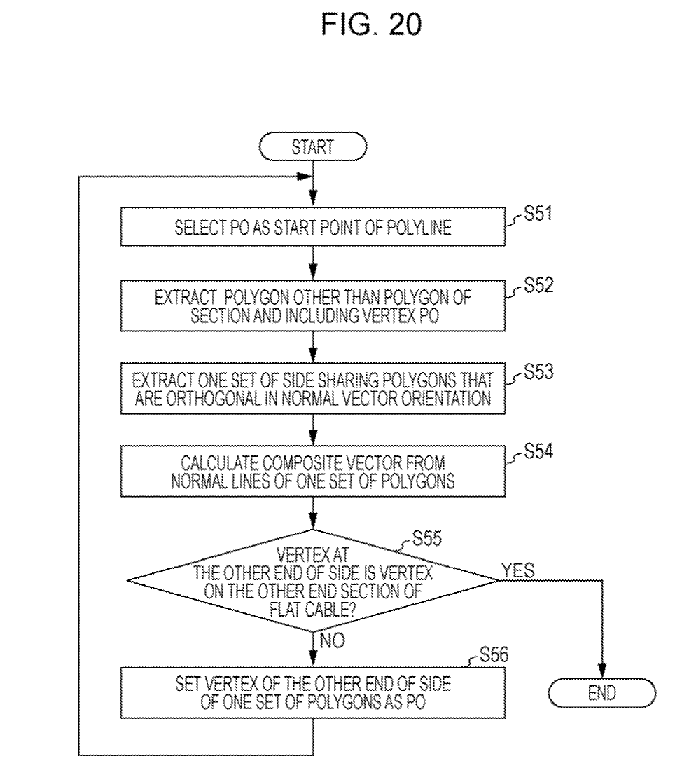

FIG. 20 illustrates an example of a flowchart of a polyline calculating process to be executed for a flat cable.

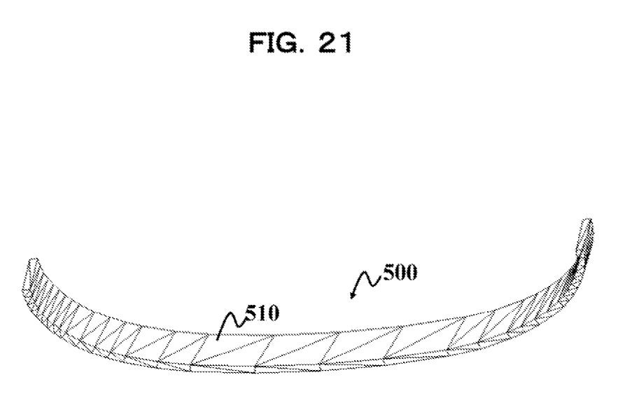

FIG. 21 is a diagram illustrating an example of a solid model of a harness which is prepared with polygons and has a quadrilateral sectional shape.

The shape of a flat harness 500 in FIG. 21 corresponds to the shape of the flat harness 400 in FIG. 17. The flat harness 500 is configured by closely covering the surface of the flat harness 400 with a plurality of polygons. Since the flat harness 500 is configured by combining the plurality of polygons with one another, it may be difficult for the flat harness 500 to accurately express the curved surface of the flat harness 400. The flat harness 500 is prepared so as to be held in a fixed error range which has been defined in advance when the shape of the flat harness 400 is to be prepared on the basis of polygon data. Normal vectors are defined for respective polygons, respective vertices of respective polygons, or respective polygons and respective vertices of respective polygons. 510 is one of polygons included in the flat harness 500.

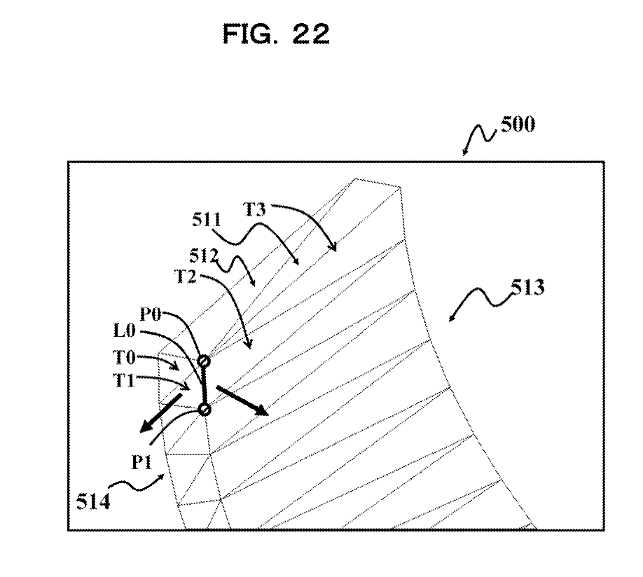

FIG. 22 is an enlarged diagram illustrating an example of a harness having a quadrilateral section shape which has been prepared with polygons.

Polygons 511 and 512 are plane and correspond to the section 410 of the flat harness 400. A polygon group 513 expresses a curved surface and corresponds to the first side surface 430 of the flat harness 400. A polygon group 514 also expresses a curved surface and corresponds to the second side surface 420 of the flat harness 400.

In a flat harness, a vector for shifting a polyline to the center of the harness is expressed by a composite vector of two normal vectors. Therefore, selection of a polyline used is limited. Incidentally, the center of the section of a flat cable may be set on, for example, the center of gravity of a rectangle.

The path calculation unit 14 selects a vertex PO from within vertices positioned on an outer edge of a section as a starting point of the polyline concerned (S51). A side of a polygon leading to the vertex PO serves as the polyline. Thus, the path calculation unit 14 extracts a polygon including the vertex PO from polygons other than the polygons included in the section of the flat harness (S52). In the example in FIG. 22, the path calculation unit 14 extracts four polygons, that is, polygons T0 and T1 included in a polygon group 514 of the second side surface and polygons T2 and T3 included in a polygon group 513 of the first side surface.

The path calculation unit 14 extracts a set of polygons directions of normal vectors of which are almost orthogonal to each other and that share one side from the polygons extracted at S52 (S53). The side which is shared by the extracted polygons serves as a line segment that configures the polyline concerned. LO in FIG. 22 is a side which is shared by the polygons T1 and T2 directions of normal vectors of which are almost orthogonal to each other share.

In addition, the path calculation unit 14 calculates a composite vector from normal lines of one set of polygons extracted at S53 (S54). The direction of the composite vector corresponds to a direction in which the curve that passes on the surface of the flat cable is oriented when it is shifted to the passing point of the flat cable. The path calculation unit 14 judges whether the vertex on the other end of the side which is shared by one set of polygons extracted at S53 is the vertex on the other end section of the flat cable (S55). When the vertex on the other end of the side which is shared by one set of polygons extracted at S53 is the vertex on the other end section of the flat cable (S55: Yes), execution of the process is terminated. On the other hand, when the vertex on the other end of the side which is shared by one set of polygons is not the vertex on the other end section of the flat cable (S55: No), the path calculation unit 14 sets the vertex on the other end of the side which is shared by one set of polygons extracted at S53 as the vertex PO (S56) and executes the processes at S51 and succeeding steps. The path calculation unit 14 repeats execution of the above mentioned processes until the polyline reaches the other end surface. As a result, it is allowed to acquire the polyline that passes the surface of the flat harness. In addition, it is allowed to specify the direction of a vector used to shift each side or each vertex included in the polyline to the passing point on the section of the flat harness.

The three-dimensional CAD device disclosed hereinabove is allowed to calculate a flexible body model which may be used in simulation of the operation of a linear component from a liner component which is expressed in the form of a three-dimensional rigid body model.

The three-dimensional CAD program disclosed hereinabove allows provision of a system of calculating a flexible object model which may be simulated as a linear flexible object in DMU from a shape model of the linear flexible object which has been prepared as a solid model (a rigid body) with the aid of three-dimensional CAD.

The above mentioned embodiments may be used to design a product with the aid of three-dimensional CAD.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A non-transitory computer-readable medium storing a three-dimensional simulation program that is executed in a three-dimensional simulation apparatus including a memory that stores shape data of a three-dimensional model of a designing object device including a linear flexible object, the three-dimensional simulation program causing the three-dimensional simulation apparatus to:
read out the shape data stored in the memory;
specify data that forms sections of the linear flexible object from the read-out shape data;
determine reference positions on the specified sections;
specify data that forms a side surface that connects together the sections of the linear flexible object from the read-out shape data;
extract a curve that passes on the side surface that connects together the sections from the specified side surface forming data;
specify a distance from an outer edge of the section that the extracted curve passes to the reference position on the section;
specify a normal direction of the side surface at the position of the extracted curve;
specify a path that connects together the reference positions on the sections by shifting the curve by the amount corresponding to the specified distance in a direction opposite to the specified normal direction of the side surface; and
specify a flexible body model of the linear flexible object from the shape of each section, the reference positions and the path.

2. The non-transitory computer-readable medium according to claim 1, wherein the shape data includes a plurality of pieces of polygon data including vertices and normal directions of the vertices and the normal direction of the side surface is specified from the normal line direction of the vertex of each polygon data.

3. The non-transitory computer-readable medium according to claim 1, wherein other pieces of polygon data that coincide with the above polygon data in normal direction of vertex and are adjacent to the above polygon data are sequentially extracted to specify the sections of the linear flexible object from the extracted polygon data.

4. The non-transitory computer-readable medium according to claim 1, wherein in the case that the section of the linear flexible object is circular, a polyline that connects together polygon data forming the specified sections is extracted, and the polyline is shifted by the amount corresponding to the length of the radius of the specified section in a direction opposite to the normal direction of the vertex of each polygon data included in the extracted polyline to specify the path of the linear flexible object.

5. The non-transitory computer-readable medium according to claim 1, wherein the shape data includes a plurality of pieces of surface data that allow to specify a normal line on a curved surface that defines a surface of a component, and surface data that forms a plane is extracted from the plurality of pieces of surface data to specify the section of the linear flexible object.

6. The non-transitory computer-readable medium according to claim 1, wherein in the case that the section of the linear flexible object is circular, a curve that passes on the side surface that connects together the sections is shifted by the amount corresponding to the length of the radius of the section in a direction opposite to the normal direction of the curve.

7. A three-dimensional simulation apparatus comprising:
a memory that stores shape data on a three-dimensional model of a designing object device including a linear flexible object; and
a processing unit executing:
reading out the shape data stored in the memory,
specifying data that forms sections of the linear flexible object from the read-out shape data;
determining reference positions on the specified sections;
specifying data that forms a side surface that connects together the sections of the linear flexible object from the read-out shape data;
extracting a curve that passes on the side surface that connects together the sections from the specified side surface forming data;
specifying a distance from an outer edge of the section that the extracted curve passes to the reference position on the section;
specifying a normal direction of the side surface at the position of the extracted curve;
specifying a path that connects together the reference positions on the sections by shifting the curve by the amount corresponding to the specified distance in a direction opposite to the specified normal direction of the side surface; and
specifying a flexible body model of the linear flexible object from the shape of each section, the reference positions and the path.

8. A three-dimensional simulation method to be executed by a computer comprising:
to read out the shape data stored in a memory;
to specify data that forms sections of the linear flexible object from the read-out shape data;
to determine reference positions on the specified sections;
to specify data that forms a side surface that connects together the sections of the linear flexible object from the read-out shape data;
to extract a curve that passes on the side surface that connects together the sections from the specified side surface forming data;
to specify a distance from an outer edge of the section that the extracted curve passes to the reference position on the section;
to specify a normal direction of the side surface at the position of the extracted curve;
to specify a path that connects together the reference positions on the sections by shifting the curve by the amount corresponding to the specified distance in a direction opposite to the specified normal direction of the side surface; and
to specify a flexible body model of the linear flexible object from the shape of each section, the reference positions and the path.
